(19) United States
(12) Patent Application Publication
(10) Pub. No.: US 2014/0019063 A1
(43) Pub. Date: Jan. 16, 2014

(54) SHOE SENSOR SYSTEM

(71) Applicants: Mike McHugh, Plymouth, MN (US); Roger Roisen, Minnetrista, MN (US)

(72) Inventors: Mike McHugh, Plymouth, MN (US); Roger Roisen, Minnetrista, MN (US)

(73) Assignee: Horse Sense Shoes, LLC, Plymouth, MN (US)

(21) Appl. No.: 13/979,363

(22) PCT Filed: Jan. 13, 2012
(86) PCT No.: PCT/US12/21282

§ 371 Date: Sep. 23, 2013

Related U.S. Application Data
(60) Provisional application No. 61/432,289, filed on Jan. 13, 2011.

(51) Int. Cl. G06F 19/00

(52) U.S. Cl. CPC G06F 19/32
USPC 702/19

(57) ABSTRACT

A system includes a pressure sensor and circuitry to collect information from the pressure sensor and transmit the information to a server. The pressure sensor and circuitry are formed as an integrated node adapted to be placed to sense pressure in the foot of an animal. The server processes the information to one or more devices.

### RELATED APPLICATION

This application claims priority to U.S. Provisional Application Ser. No. 61/432,289 (entitled Shoe Sensor System, filed Jan. 13, 2011) which is incorporated herein by reference.

### BACKGROUND

Prior systems attempted to measure physiological properties of various animals, but typically involved sensors coupled to remote transponders. This resulted in separate placement of the sensors and transponders, increasing the complexity of using such devices. The information collected from such sensors was stored for later analysis.

### SUMMARY

A sensor system for use in measuring physiological properties of an animal, such as foot or hoof pressure of a horse, transmits sensed information to a local server. The local server may provide real time analysis and information to one or more devices, such as personal computers, laptops, and smart phones via one or more communication protocols. Various embodiments provide for real time information which can be directly associated with visual performance of the animal.

### BRIEF DESCRIPTION OF THE DRAWINGS

FIG. 1 is a top view of a horse shoe containing wireless sensors according to an example embodiment.

FIG. 2 is a block schematic diagram view of a wireless pressure sensor according to an example embodiment.

FIG. 3 is a block diagram of a wireless pressure sensor according to an example embodiment.

FIG. 4A is a block diagram of a strain gauge wireless sensor according to an example embodiment.

FIG. 4B is a block diagram of an alternative strain gauge according to an example embodiment.

FIG. 5 is a block diagram illustrating a track environment incorporating wireless sensors according to an example embodiment.

FIG. 6 is a block diagram of a patch wireless sensor system according to an example embodiment.

FIG. 7 is a block diagram illustrating a disposable multiple sensor wireless sensor patch according to an example embodiment.

FIG. 8 is a block side view of the disposable multiple sensor wireless sensor patch according to an example embodiment.

FIG. 9 is a block diagram of a stable type environment incorporating wireless sensors according to an example embodiment.

FIG. 10 is a block diagram illustrating a tracking interface according to an example embodiment.

FIG. 11 is a block diagram illustrating a multiple diverse sensor system according to an example embodiment.

FIG. 12 is a web page based interface for selecting animals being monitored and providing hoof temperature information according to an example embodiment.

FIG. 13 is a web page based interface for selecting animals being monitored and providing additional hoof temperature information according to an example embodiment.

FIG. 14 is a web page based interface for selecting animals being monitored and providing hoof temperature and pressure information according to an example embodiment.

FIG. 15 is a web page based interface providing hoof pressure information in graphical form for different portions of a hoof according to an example embodiment.

FIG. 16 is a web page based interface providing hoof pressure information over time in graphical form for different portions of a hoof according to an example embodiment.

FIG. 17 is a mobile web page based interface for selecting animals being monitored according to an example embodiment.

FIG. 18 is a mobile web page based interface illustrating pressure information for a selected animal according to an example embodiment.

FIG. 19 is an example computer system for implementing one or more methods or algorithms according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Various embodiments include one or more of sensors for pressure and temperature affixed inside a horseshoe, on a hoof, or on the body of a horse or other animal to be monitored. Further animals include for example, cattle, sheep, goats, and other livestock. Sensed physiological properties or parameters are transmitted via a wireless RF radio. The data is collected and uploaded to a server. The server data may be charted over time and available via the website.

In one embodiment, a tactile sensor is connected to a resistor and a supply voltage such as VCC that may be provided by a battery. Resistor divider output is monitored with a data convertor-analog to digital convertor and a sampled voltage is converted to a binary number with a microprocessor. The microprocessor converts the number to a digital signal that is then moved to the RF radio for transmission. The transmitted data may be further transmitted to a server via a network. The server processes the data and provide for display of the data on a website viewable by a client device, such as a computer, including mobile devices.

The sensor and circuitry are integrated in one embodiment to form a node that may be placed in a small hole formed in the shoe or between the shoe and the hoof or foot of an animal, also simply referred to as a foot. The integrated sensor and circuitry may be formed within an enclosure or pad to protect them. Nodes may transmit to a server independently for example, via a ZigBee IEEE 802 network or other type of network device providing a suitable communication range in a compact format. In some embodiments, multiple nodes may be networked with a primary node per hoof, or per animal collecting and buffering data from the other nodes and transmitting it to the server. The sensor and circuitry of a node may be encapsulated in plastic or other material and sealed, such as hermetically sealed to protect it from harsh environmental conditions.

In various embodiments, each node includes at least one sensor and circuitry, such as a microprocessor and transceiver or radio. There may be one or more such sensors and circuitry in each foot or hoof. A common hoof application utilizes three sets of pressure sensors and circuitry in each hoof. Data is collected by the microprocessor and uploaded via a wireless network to a server. The data may be buffered and sent in bursts in some embodiments. The server may be coupled to the Internet in various embodiments. Each independent set of sensors may upload data, or a lead sensor and circuitry may collect all data from the hooves of a horse or other animal and upload the collected information. In further embodiments, applications may include sensors gathering other data on the horse not located on the hoof or shoe at all, for example a diagnostic patch on the horse may be reading and collecting data of heart beat rate or breathing rate, or body temperature and uploading to the internet. Strain gauges may be used on various parts of the hoof in further embodiments.

In some embodiments, the server provides a real time website with a graphical user interface to allow a user to view data for one or more horses and to quickly display data for each individual hoof. Historical data for a horse may also be processed and compared to current data. Trend analysis may be performed to generate alerts if the trends indicate undesired changes in pressure or other measured property. Alerts may also be generated when a particular sensor reading such as temperature meets a selected threshold. Pattern matching may be performed in further embodiments to determine if current patterns in pressure, such as three pressures on one hoof showing undesired pressure patterns when compared to predetermined pressure patterns. Such undesired patterns may also result in alerts. The alerts may take the form of an SMS message or other form of instant communication such as Twitter™ messages.

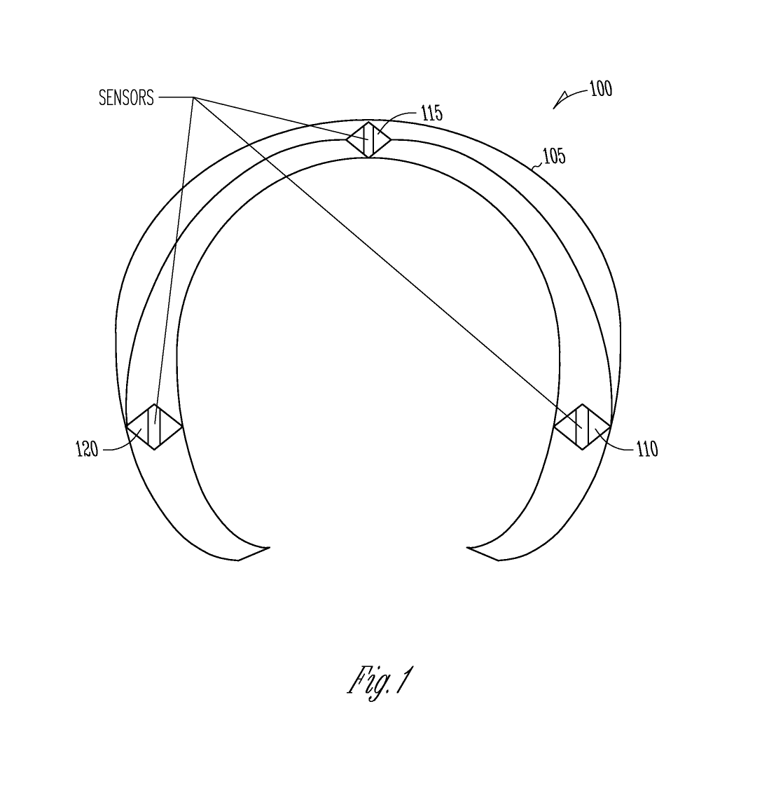

FIG. 1 is a top view 100 of a horse shoe 105 containing wireless sensors 115 according to an example embodiment. In one embodiment, the sensors are pressure sensors and are distributed to three positions about the horse shoe, corresponding to the heal or rear and two positioned opposite each other near the toe or front of the hoof. The sensors fit between the horseshoe and the hoof, allowing the sensing of pressure at three different points. Further pressure sensors may be placed on the horseshoe in further embodiments. Temperature sensors may also be positioned on the shoe in further embodiments. The temperature sensors may be included with the pressure sensors, forming a wireless sensor that senses both pressure and temperature.

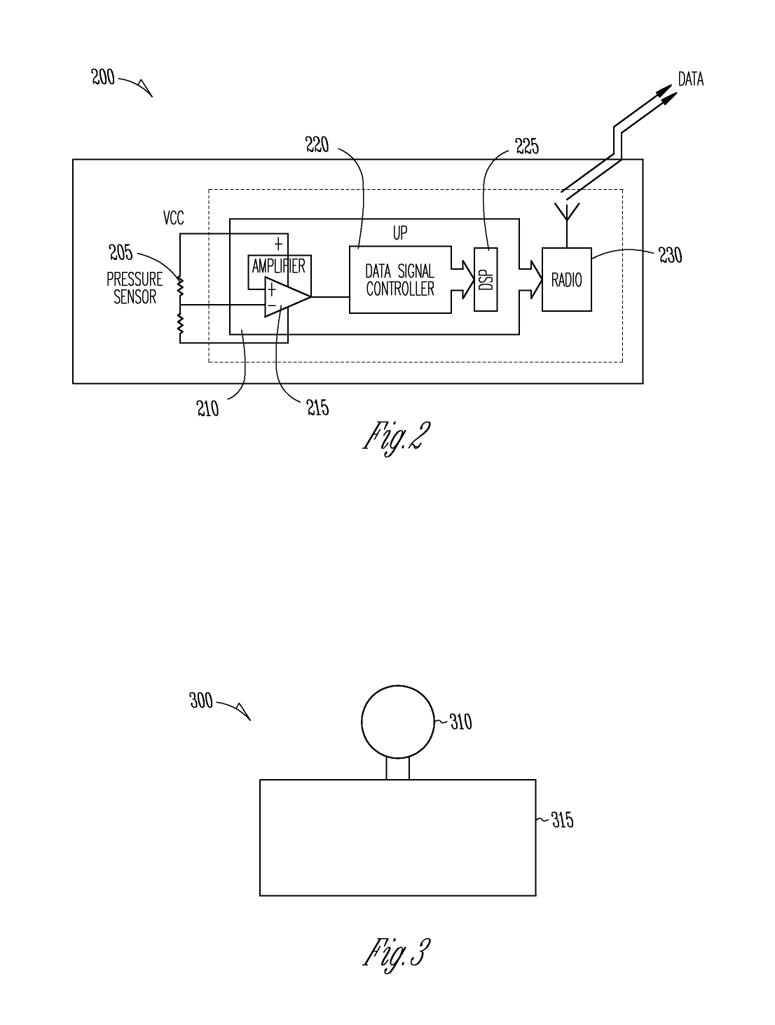

FIG. 2 is a block schematic diagram view of a wireless pressure sensor node 200 according to an example embodiment. The pressure sensor may be one or many different types of electrically actuated pressure sensing devices such as pressure sensitive resistor 205 in a resistive divider coupled to circuitry 210. Circuitry 210 includes an amplifier 215 coupled to a microprocessor 220 and digital signal processor 225. Sampled signals from the resistor 205 are processed to provide a signal representative of the sensed pressure. The signal is transmitted by a radio 230 along with an ID that may be used to uniquely identify the animal, and the precise location of the node on the animal. In further embodiments, a unique node ID may be transmitted, and later correlated with information to identify the location of the node on the animal.

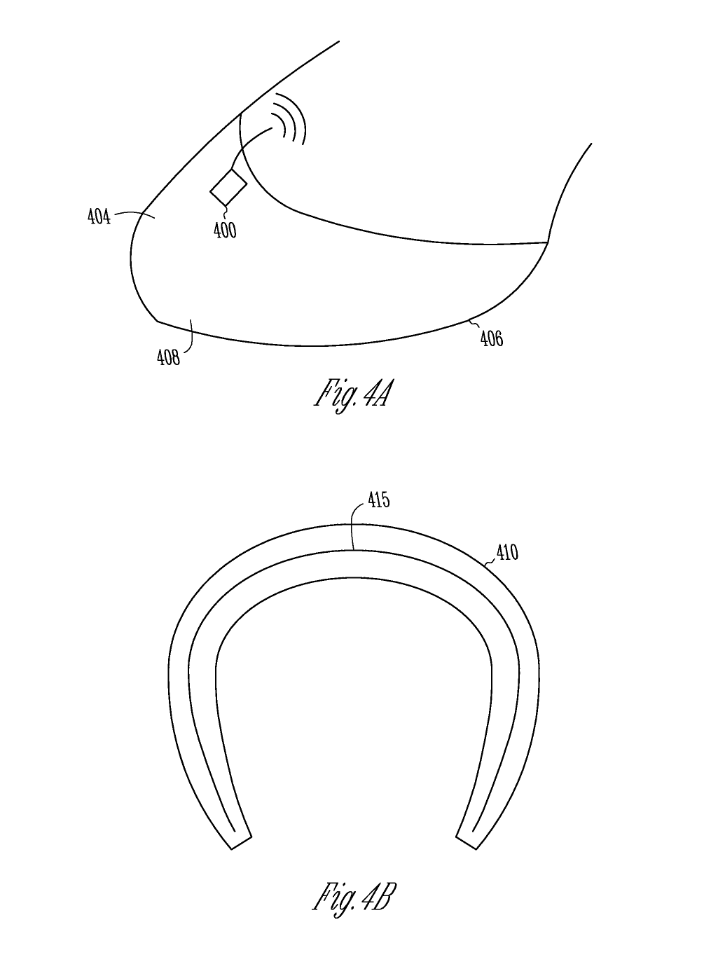

The node 200 comprising integrated sensor 205 and circuitry 210 may be formed within an enclosure or pad to protect them as illustrated in FIG. 3 at 300. FIG. 3 is a block diagram of a wireless pressure sensor node according to an example embodiment. In one embodiment, the node includes a sensing element 310 and circuitry 315. The sensing element 310 may be placed between the hoof and the horseshoe, with the circuitry positioned adjacent to the horseshoe/hoof interface. In one embodiment, one hoof may have three or more nodes that may transmit to a server independently, or multiple nodes may be networked (for example, via a ZigBee network transmitter or transceiver) with a primary node per hoof, or per animal collecting data from the other nodes and transmitting it to the server. The sensor and circuitry of a node may be encapsulated in plastic or other material and sealed, such as hermetically sealed to protect it from harsh environmental conditions.

In one embodiment, the integrated node is shaped to be inserted into a hole formed in a horse shoe, or otherwise on the horse shoe to be coupled to a hoof such that the node is positioned to measure a parameter corresponding to at least one of impact, force, pressure, weight, and stride.

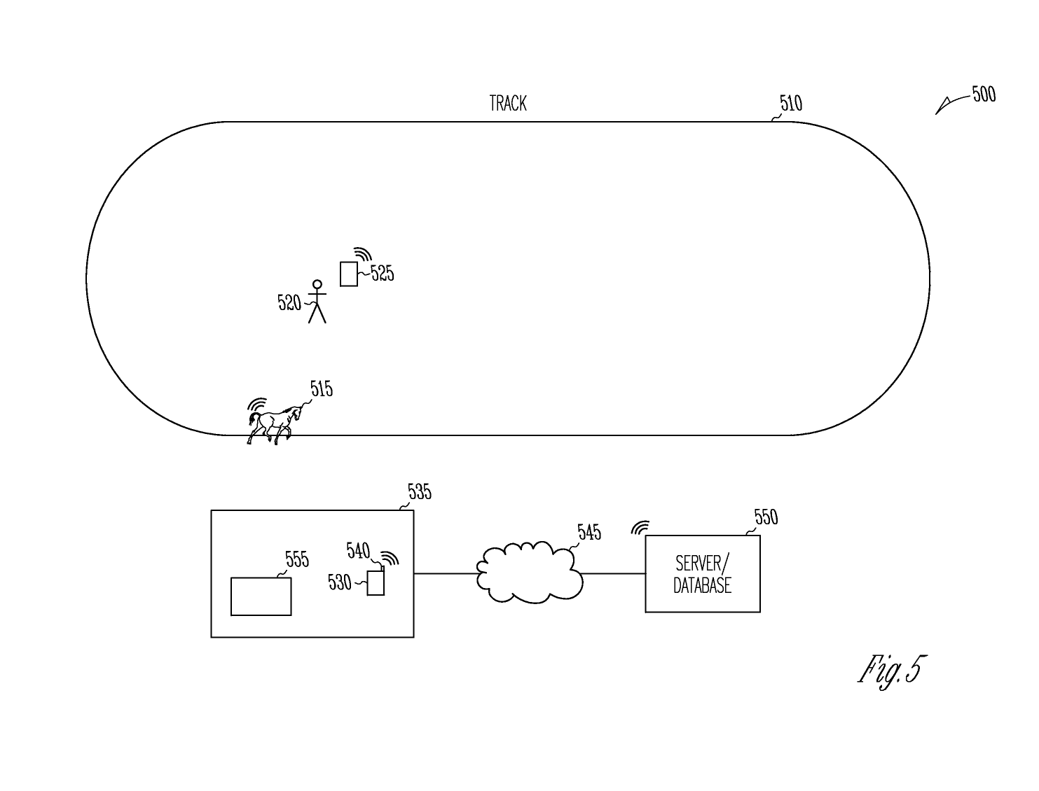

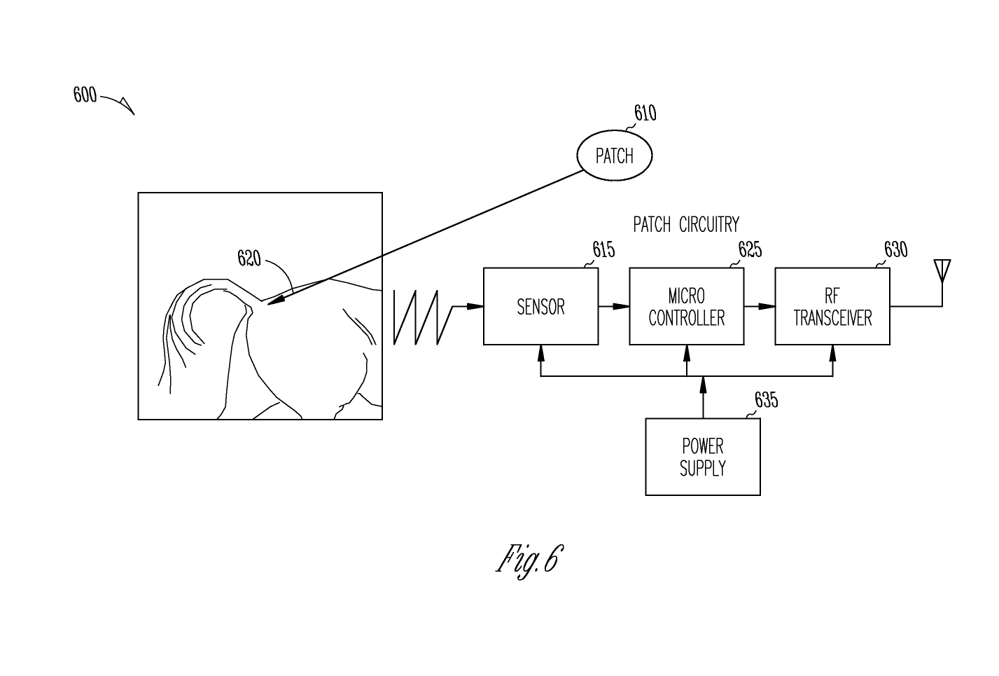

FIG. 4A is a block diagram of a strain gauge based wireless sensor 400 according to an example embodiment. In one embodiment, the sensor 400 is coupled to a wall 404 of a hoof 406. The strain gauge may be used to sense stress or cracks occurring in the hoof, such as quarter cracks in the quarter 408 of hoof 406. The wireless sensor 400 transmits signals representative of the strain.

FIG. 4B is a block diagram of horseshoe 410 having a continuous embedded strain gauge 415. The strain gauge 415 may provide an overall measure of strain in the horseshoe as the horse or other animal moves. In one embodiment, the strain is measured along the length of a horseshoe to hoof interface. The strain gauge 415 may include circuitry to process and transmit signals representative of the strain. In further embodiments, one or more nodes may contain global positioning system components to provide location information. Location information may also be provided based on one or more triangulation techniques in further embodiments.

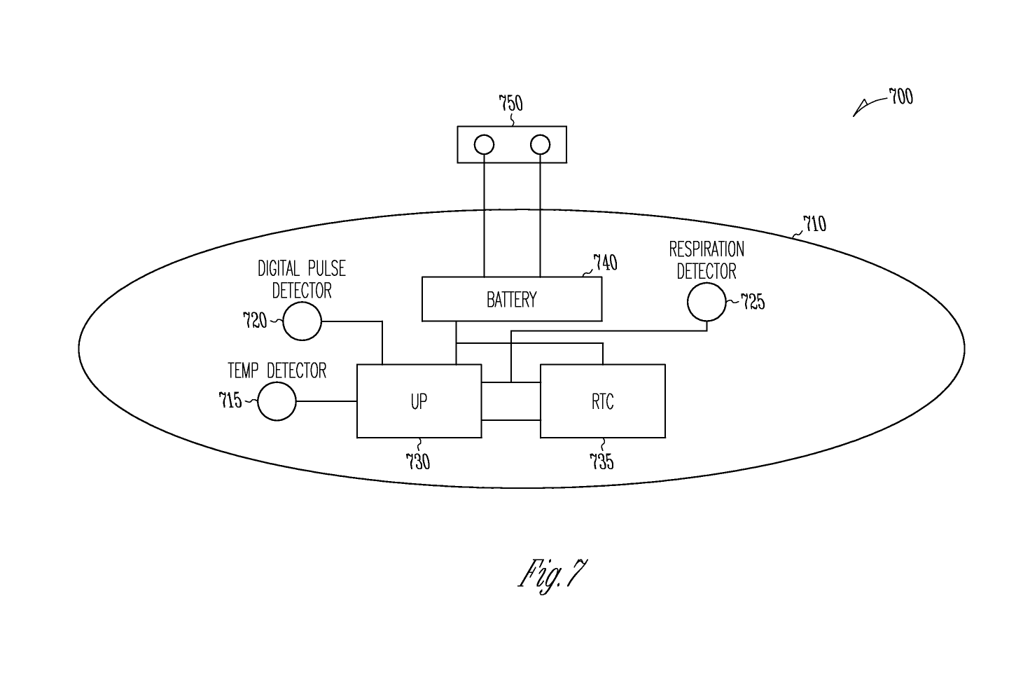

FIG. 5 is a block diagram illustrating a track environment 500 incorporating wireless sensors according to an example embodiment. A training track 510 is shown with a horse 515 that is equipped with one or more sensors, including pressure, temperature, strain, and other sensors that transmit signals representative of physiological properties of a horse or other animal. A trainer is indicated at 520, along with a mobile wireless device 525 that contains information from the sensors.

In one embodiment, the sensor information is transmitted to one sensor on the animal 515, and then is received by a collection device or system 530 in a building, such as a barn or stable 535. The system 530 need not be located in the barn in various embodiments, and may be comprised of a computer system such as a laptop or other type of computer that receives transmissions from the sensors. Thus it should be located within range of animal being monitored. When there are instances that the animal is out of range the information may be saved on the microprocessor memory and sent to the router, seconds, minutes, hours or days later after the animal is back within range of the collection device. In one embodiment, a universal serial bus (USB) type of receiver 540 or a wireless router may be employed to receive the signals transmitted from the sensor nodes, or primary node on the animal. The system 530 is coupled to a network 545, such as the Internet, to provide the sensed data to a server 550. The server 550 may include a database, and programming to compile the data for each horse.

The data may be sent from the server 550 through one or more wireless networks to the mobile device 525 to provide information about the horse being monitored. The wireless device may either access a secure account on the server corresponding to the horses being trained by the trainer 520, or in some embodiments, location information of the mobile device and of the horses or system 530 may be provided to the server 550 and used to access information likely to be relevant to the trainer 520 or horse handler, vet Ferrier, or other person or persons.

In some embodiments, data is collected as the animal runs on the track 510, or in any environment such as for example paddock, jump course, or any other recreational, sporting, riding, or grazing environment. The data may include pressure, shock, temperature, strain, and other information. Shock information may be obtained if the sampling frequency is high enough to measure expected ranges of shock. In further embodiments, a node may include an accelerometer to provide the shock data. The data may be time stamped, provided with an ID to identify either the node, or the animal and location on the animal, optionally buffered, optionally processed, and transmitted to the system 530. As transmission ranges of the nodes increases, the nodes may themselves couple directly to a network and send the data directly to server 550. The information may then be processed and compiled to provide real time stride information for the animal being monitored.

In some embodiments, excess shock can cause internal bleeding, hemorrhaging, or other undesirable effect on the muscular or skeletal condition of the animal. The shock information may be used to inform a jockey to switch leads down the stretch of a run around the track. The lead foot encounters different stress than the trailing foot. Switching leads can help distributed the cumulative shock effects between the two front feet. Other performance animals may have related reasons to reduce stress impact, such as when a horse jumps a fence and lands for example, or a barrel horse that plants to turn. Such information can be utilized in a range of training and competitive situations to enhance performance techniques unique to a particular animal such as a horse. Collected information can be utilized with video of animal activities to better recognize performance indicators.

In one embodiment, the sampling is performed at a programmable rate, and may be varied in response to training needs and to conserve node battery life. Typical sampling rates may range up to several thousand samples per second. In some embodiments, the gait of the horse may be measured and used to reprogram the sampling for a pressure sensor in real time to coincide with hoof contact with the ground. Higher sampling rates may be utilized during contact, with lower rates being used when no contact is expected. Temperature sensing sampling may occur less frequently, as various temperatures are not expected to change rapidly. Temperatures may be sensed on the order of seconds per sample or minutes between samples in some embodiments.

In some embodiments, the collected data at each node corresponds to physiological parameter measurements at desired sampling rates. The collected data may be time stamped and sent by each node to a collection point. The collection point may be one of the nodes on an animal, or may be a transceiver located within range of the normal locations of the animal. In some embodiments, the collected data at each sample point is packaged and sent to a server for processing and display of individual sensor data or a combination of one or more sensor's data for one point in time. The data may also be buffered at a node or the collection point, and statistically processed to provide averages over time for each sensor's data.

In further embodiments, multiple physiological properties are transmitted from the same sensing device or node through a single transmission means, and displayed graphically to show contemporaneous relationships between the properties. For example, pressure changes on their own might not trigger concern, and neither would temperature changes on their own. But temperature and pressure changes together (at the same time) might trigger concern in a trainer.

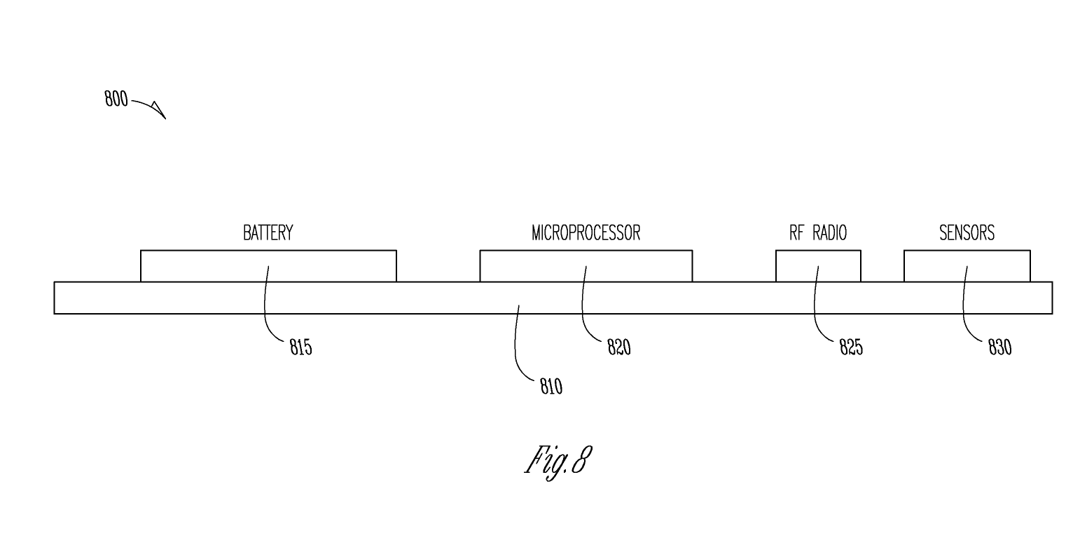

FIG. 6 is a block diagram of a patch wireless sensor system 600 according to an example embodiment. A patch 610 node having one or more sensors 615 is positioned on a desired portion of an animal as indicated at 620. The sensor provides data to a micro-controller 625 which processes the data and provides the data to an RF transceiver 630 for transmission. A power supply 635 is provided to provide power to the active components.

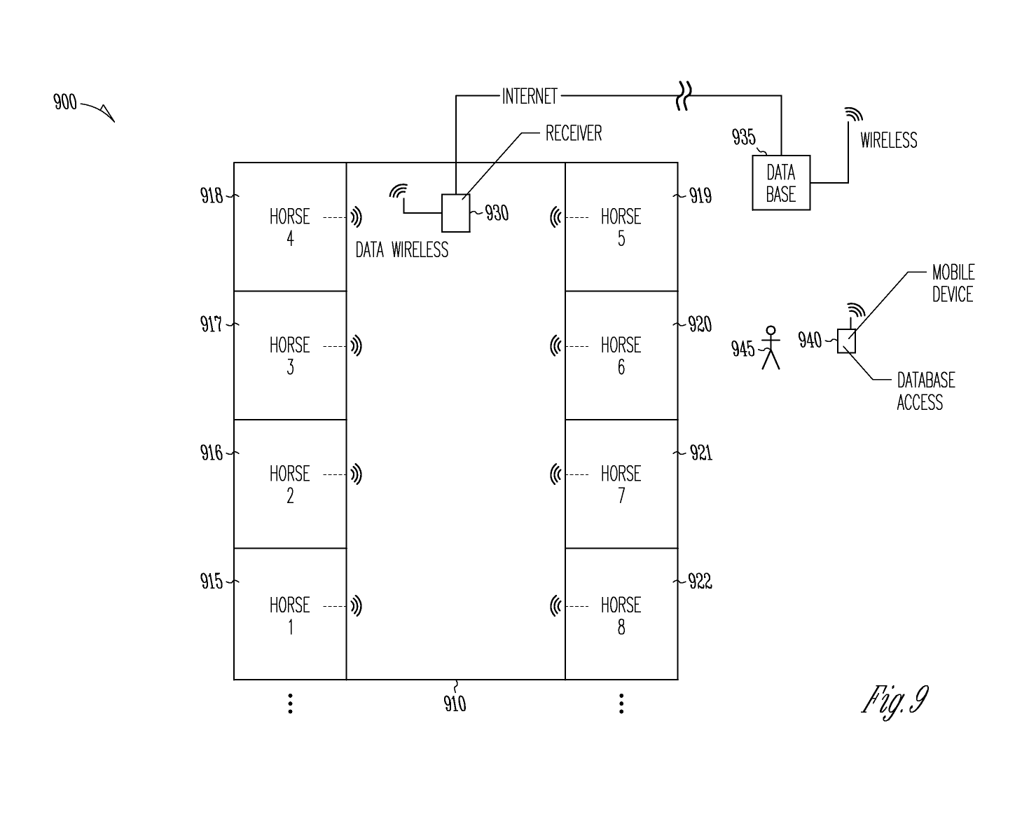

FIG. 7 is a block diagram illustrating a disposable multiple sensor wireless sensor patch 700 node according to an example embodiment. Patch 710 includes a temperature sensor 715, pulse detector 720, and respiration detector 725. Each provides signals to a microprocessor 730 via appropriate analog to digital conversion if necessary. A real time clock (RTC) 736 provides time information corresponding to the time of the measurements. A battery 740 provides power to the active components, including a transceiver that provides a unique radio address identifier as indicated at transceiver 750. In some embodiments, the transceiver 750 may be located on the patch 710, or near or adjacent the patch. The transceiver transmits information regarding the node and time stamped data collected. In further embodiments, a GPS or triangulation based location function may be added to the patch and position information may also be transmitted.

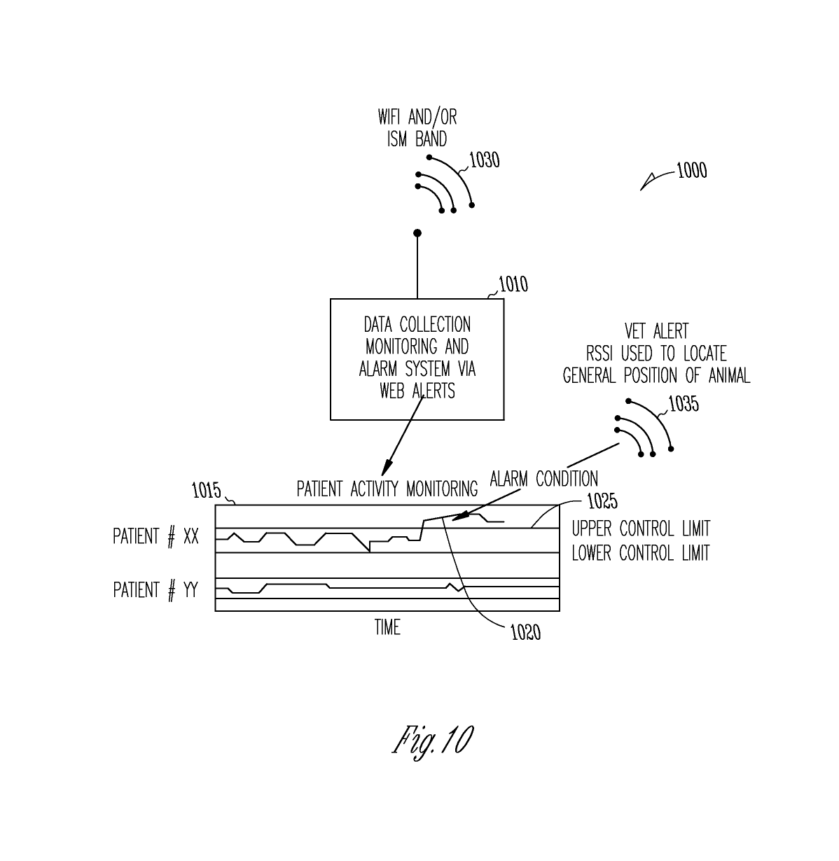

FIG. 8 is a block side view of a disposable multiple sensor wireless sensor patch 800 according to an example embodiment. The patch includes an adhesive substrate 810 supporting a battery 815, microprocessor 820, RF radio or transceiver 825 and one or more sensors 830. In further embodiments, the patch 800 may be secured to the animal in several different ways, including but not limited to separate adhesives, straps, clips, sewing, or other methods.

FIG. 9 is a block diagram of a stable type environment 900 incorporating wireless sensors according to an example embodiment. In one embodiment, the stables are designed for horses as indicated by several stalls, each corresponding to a horse indicated at 915, 916, 917, 918, 919, 920, 921, and 922. Each of the horses may have one or more nodes for sensing various properties. A receiver 930 is positioned within the environment 910, or within range of the nodes to receive information transmitted from the nodes. In some embodiments, it is convenient to position the receiver 930 close to the nodes to reduce power requirements and conserve battery life. Some nodes may include transceivers that can receive power setting information to ensure they transmit at a power level that can be reliably received by the receiver 930.

The receiver 930 transmits the collected data to a database and server 935. Server 935 may provide web pages or other format information to one or more mobile devices 940 for viewing by a user or trainer 945. In further embodiments, the server 935 may provide the information to any type of network appliance for interaction with a user.

Typical properties that are monitored by the nodes include pressure, temperature, pulse, and respiration. In further embodiments, the server 935 may transmit signals to induce a stimuli. The stimuli may be provided by nodes that include devices to provide electric current, shock wave therapy, mechanical massage, medications via pumps or topically. Some nodes may include transceivers and may be dedicated to delivering one or more of the stimuli when activated via the server. The server may receive command from the trainer to provide the stimuli, or may be programmed to provide stimuli automatically if defined parameter thresholds are met or exceeded.

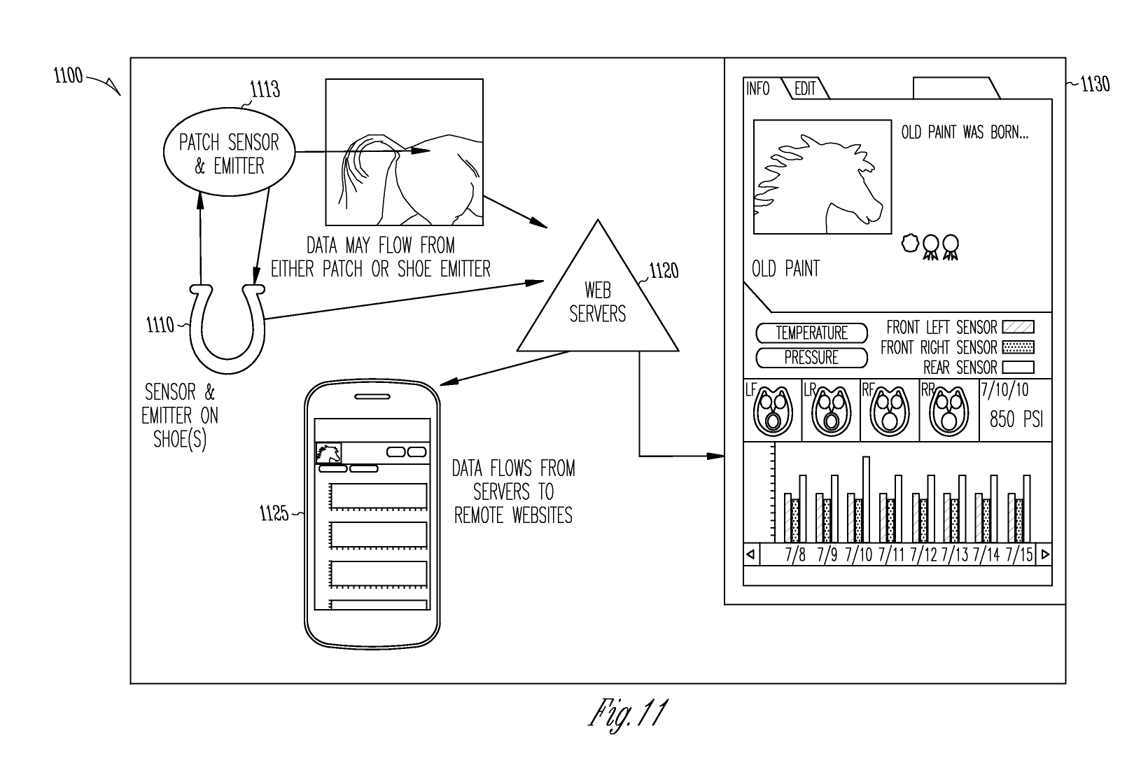

FIG. 10 is a block diagram illustrating a tracking interface 1000 according to an example embodiment. In one embodiment, alarms are provided via a data collection, monitoring, and alarm system 1010 via web alerts. Animals, referred to as patients in this example have a property being monitored as indicated at a chart 1015. The value of the property over time is indicated at 1020. When the property value exceeds an upper control limit 1025, an alert is sent as indicated at 1030. The alert may be received by a device being used by the trainer to alert the trainer or veterinarian. In one embodiment, received signal strength indicator (RSSI) 1035 may be used to provide a general location of the animal. In further embodiments, GPS or triangulation may be used. In further embodiments, accelerometer, gyroscope, orientation, or digital compass sensors may be included in nodes to identify stride analysis. The location of the animal may be crucial if the animal is sick, or may need medical attention. In some embodiments, the properties being monitored may be indicative of gestation and associated labor. Rather than keeping an animal confined, the monitoring may provide sufficient notice to retrieve the animal and provide appropriate medical care.

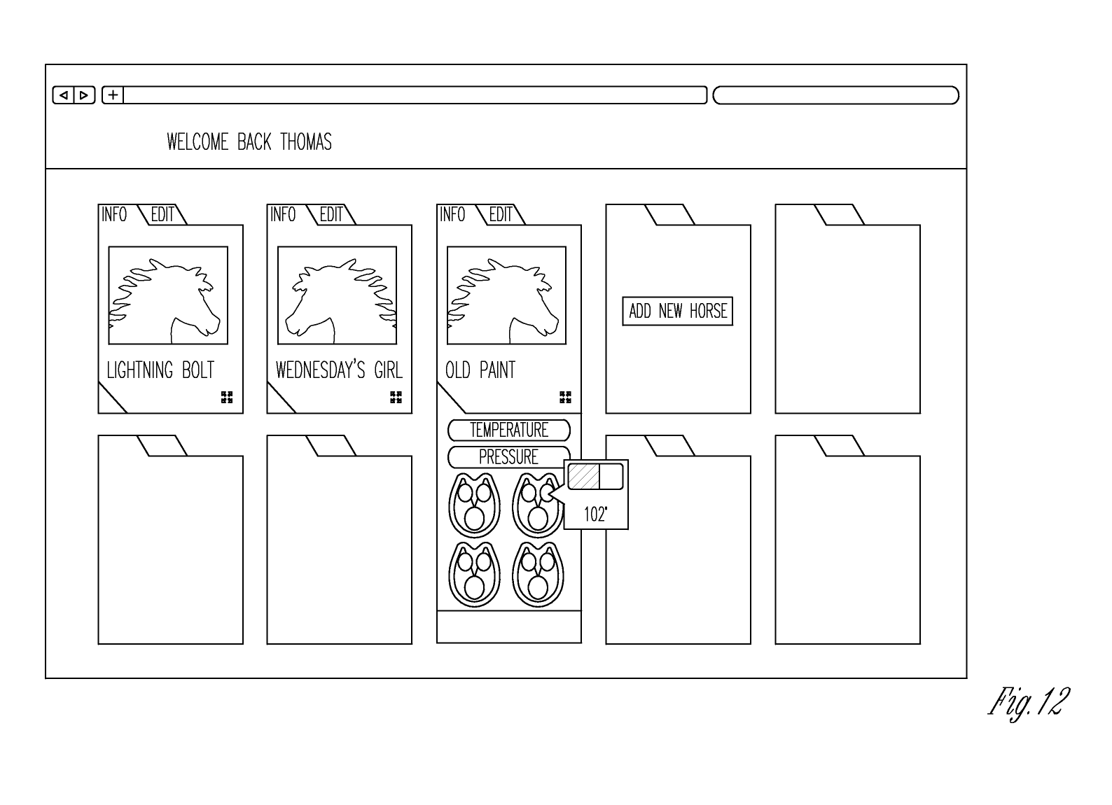

FIG. 11 is a block diagram illustrating a multiple diverse sensor system 1100 according to an example embodiment. System 1100 includes nodes on one or more horseshoes 1110 for sensing pressure, shock, and temperature, as well as one or more patch nodes 1115. The data may from all or one selected node in various embodiments to a web server or servers 1120. The data is processed, and provided to one or more network appliances 1125, 1130 for viewing and interaction with a user such as a trainer.

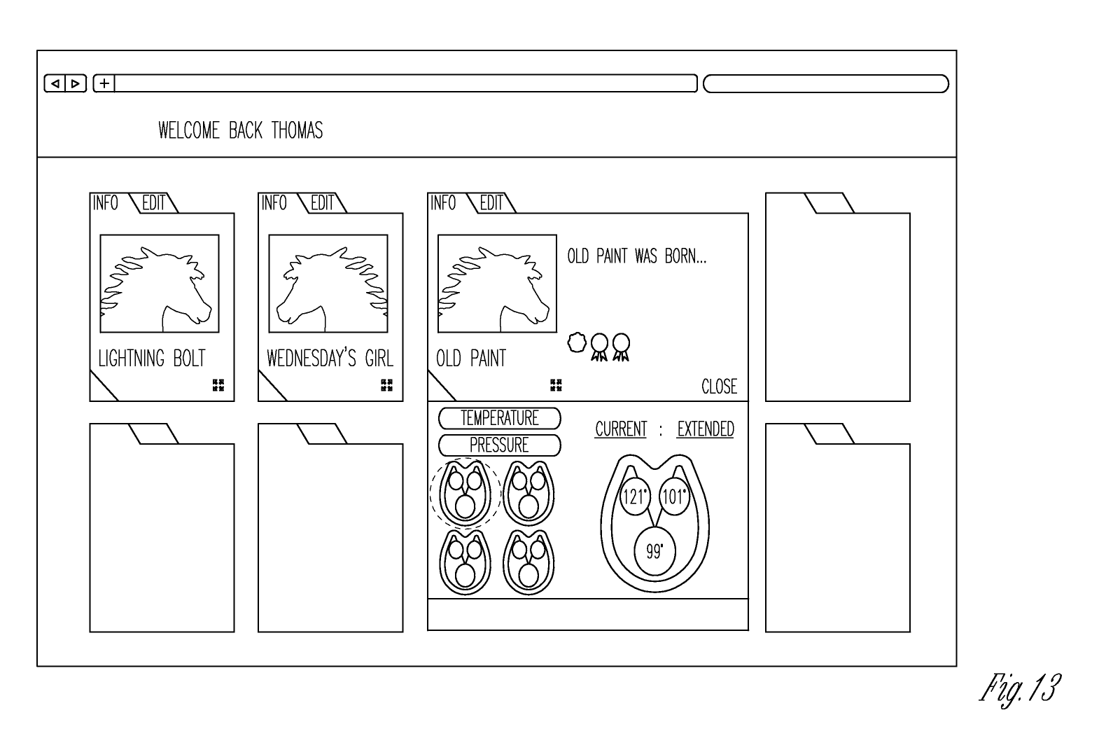

FIG. 12 is a web page based interface for selecting animals being monitored and providing hoof temperature information according to an example embodiment. The web page in this example provides links to information related to three different horses being tracked, as well as the ability to add a new horse to be monitored. In the page shown, a horse named “Old Paint” has been selected, and a diagram illustrating the four hooves and corresponding temperatures is displayed. One particular sensor or node is selected, and the temperature is illustrated for that node.

In further embodiments, in further embodiments, multiple physiological properties may be displayed to show contemporaneous relationships between the properties. For example, pressure changes on their own might not trigger concern, and neither would temperature changes on their own. But temperature and pressure changes together (at the same time) might trigger concern in a trainer. All, or selected portions of physiological data collected from the animal may be displayed together to provide an overall picture of the state of the animal at a particular time, or over a desired time frame. The data may be statistically processed to provide averages, rates of change, standard deviations, and other statistics that might be meaningful to a trainer or veterinarian.

In one embodiment, a single hoof may be selected for display of information. The information displayed for the hoof may include temperature, pressure, strain, and other sensed physiological parameters that together indicate an overall health or functioning of the hoof at various times, such as during portions of a training run, at rest, racing conditions, etc. As previously indicated, patterns or collected data during such times may be processed and compared with known healthy or unhealthy patterns to perform diagnostics regarding current health, performance, or future problems that may occur based on the patterns.

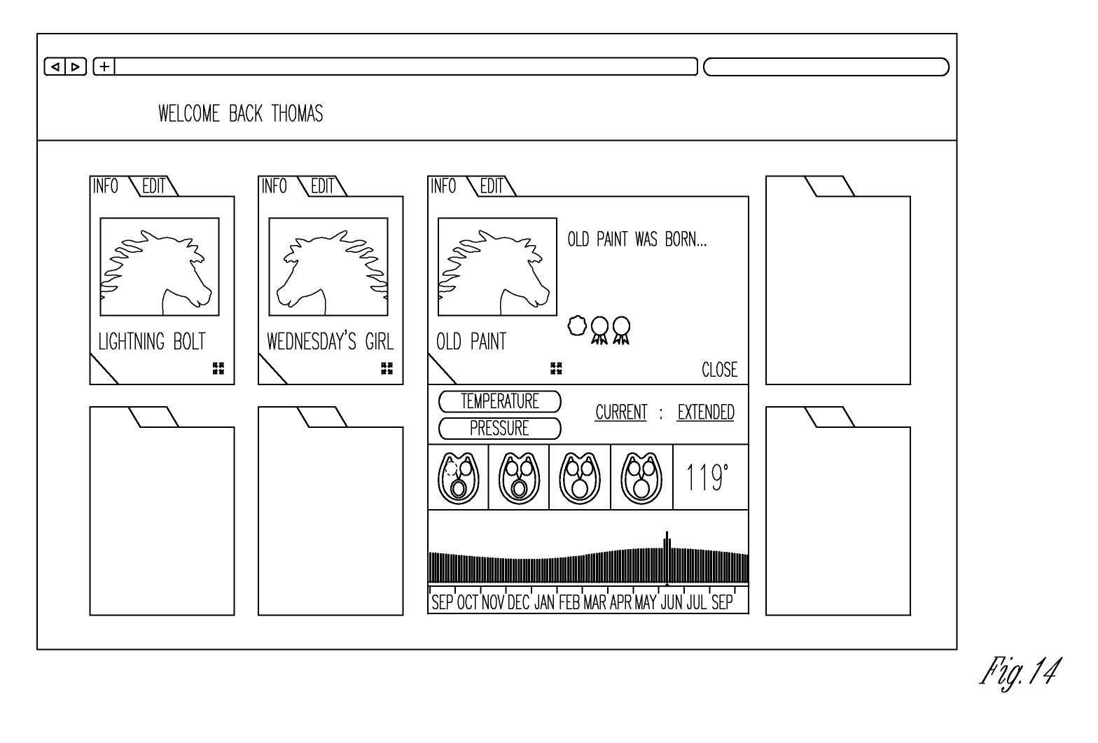

FIG. 13 is a web page based interface for selecting animals being monitored and providing additional hoof temperature information according to an example embodiment. The page illustrates further information on Old Paint, including a narrative describing the horse. The narrative could include past observations regarding training and data trends as well as any other desired information. This page shows further information regarding each node in the front left hoof. Temperature is displayed in a blown up portion of the selected hoof corresponding to each node.

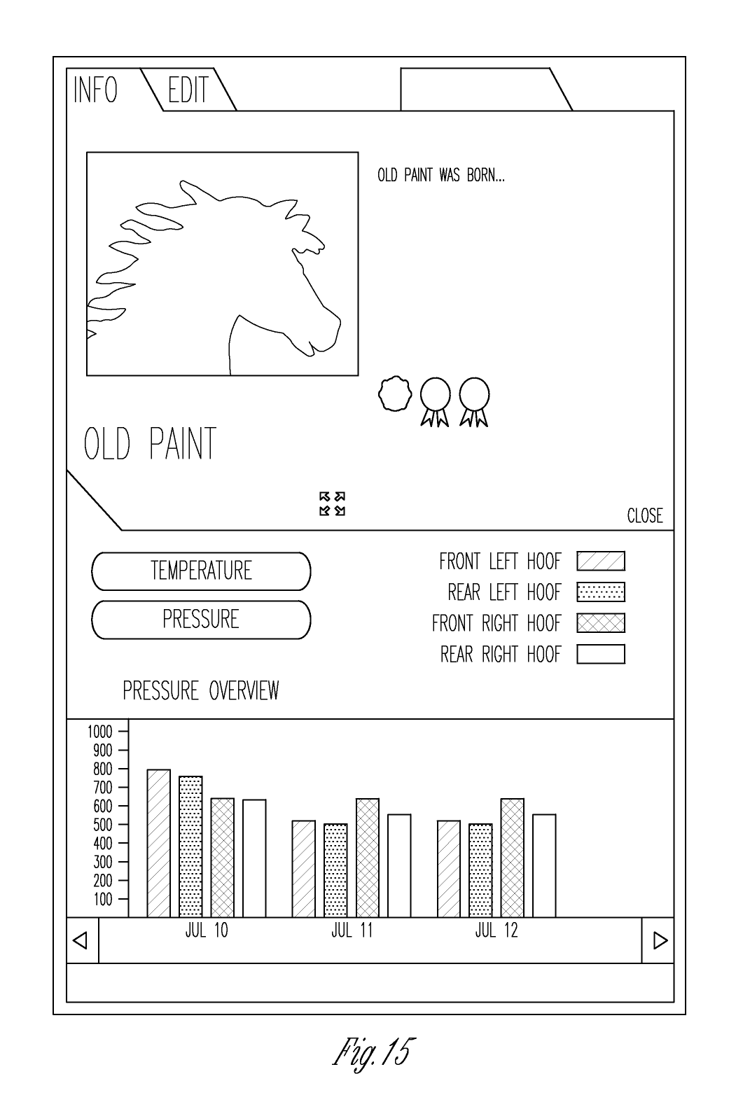

FIG. 14 is a web page based interface for selecting animals being monitored and providing hoof temperature and pressure information according to an example embodiment. This diagram includes a selected temperature sensor node with the current temperature listed and a history of average temperatures over a one year plus period. The history is in the form of a histogram. The type of graph may be varied and different statistics may be shown in the graph in further embodiments.

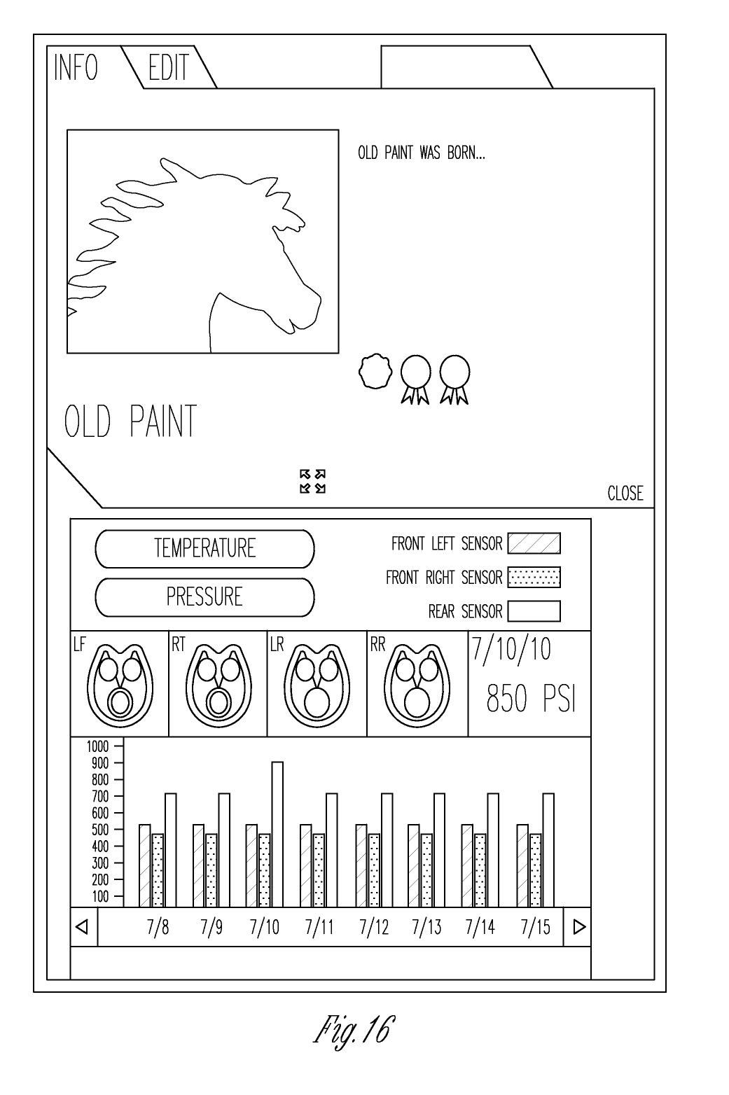

FIG. 15 is a web page based interface providing hoof pressure information in graphical form for different portions of a hoof according to an example embodiment. A bar chart illustrates the pressure for each hoof for a selected position on the hoof. The bar shading is keyed to each hoof. Pressures for three days are provided. In various embodiments, the pressure may be peak pressures, average pressures during contact of the hoof with the ground, or some other statistical figure corresponding to the data collected from each node.

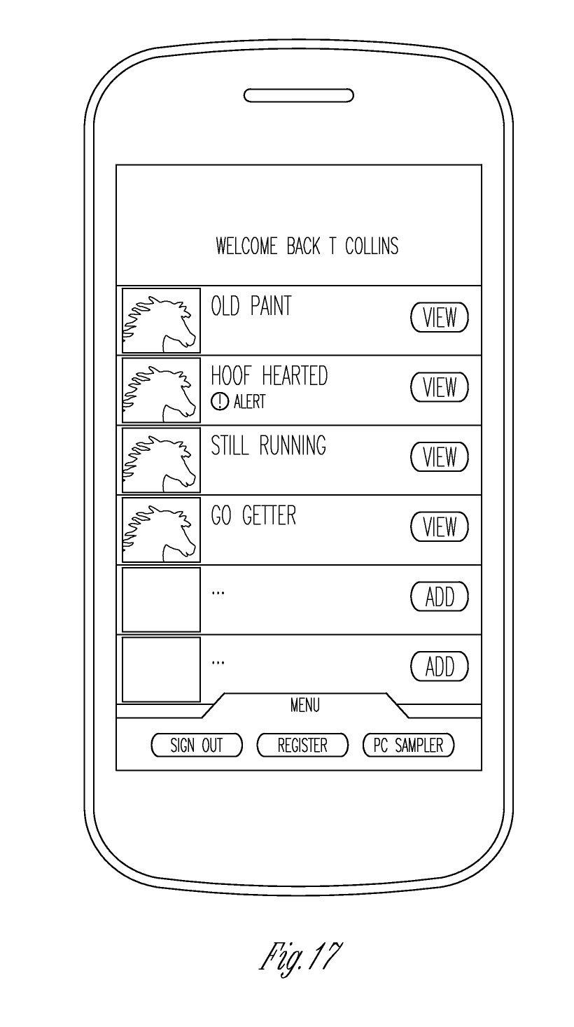

FIG. 16 is a web page based interface providing hoof pressure information over time in graphical form for different portions of a hoof according to an example embodiment. The interface provides the ability to select on particular hoof. In this example, the right front hoof has been selected. The individual nodes in the hoof are keyed to bar shading corresponding to front left sensor node, front right sensor node, and rear sensor node.

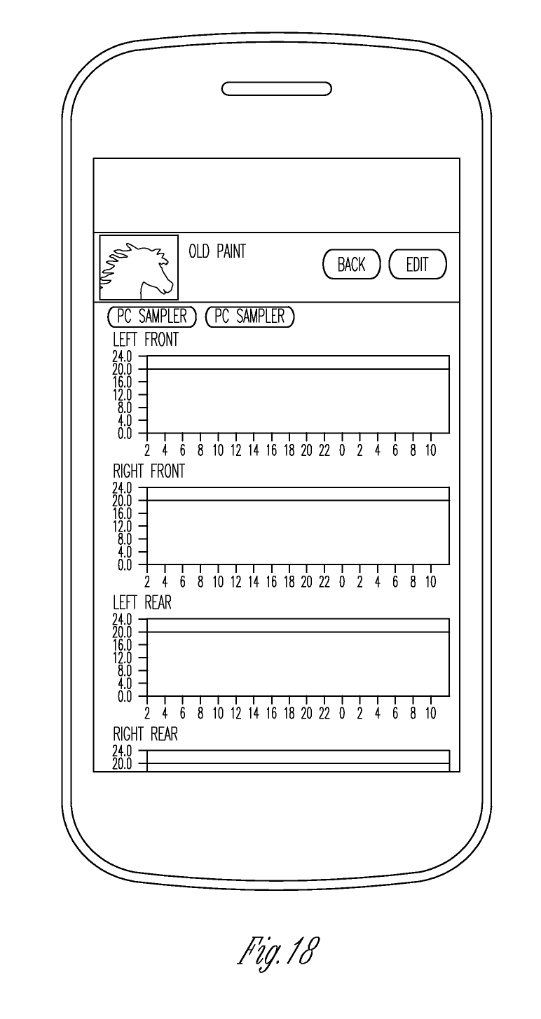

FIG. 17 is a mobile web page based interface for selecting animals being monitored according to an example embodiment. The interface is similar to that of FIG. 12 without a horse being currently selected. The user has the ability to select a displayed horse. The name of each horse and a picture may be provided on the selection menu.

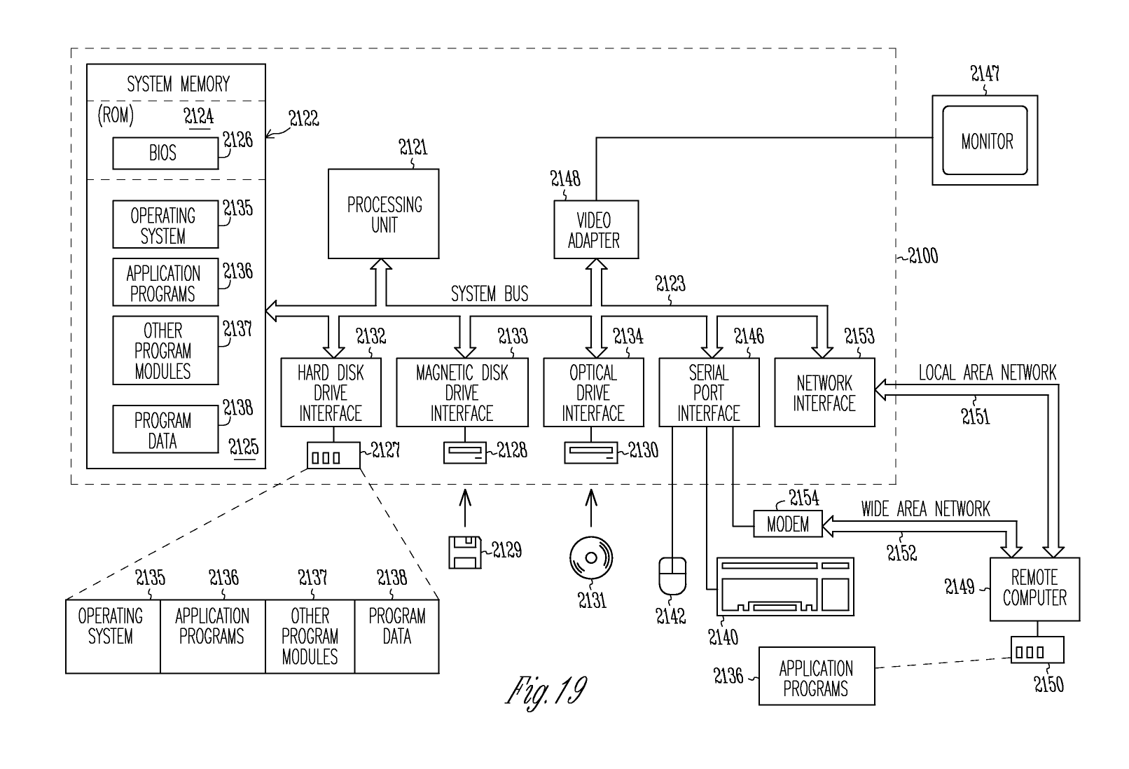

FIG. 18 is a mobile web page based interface illustrating pressure information for a selected animal according to an example embodiment. In this interface example, temporal pressure data for four hooves is provided, left front, right front, left rear, and right rear.

FIG. 19 is an example computer system for implementing one or more methods or algorithms according to an example embodiment. A hardware and operating environment is provided that may be applicable to execute drivers, compile and transmit sensor information to remote devices for viewing, receive sensor information directly from one or more sensors on a foot or hoof and transmit to a server, and other functions described herein. Many of the elements of FIG. 19 may be removed or reduced appropriate to the functions to be performed whether used in an integrated manner with the sensors to collect transmit information via an integrated transceiver, or to receive, process and retransmit information received from the transceiver.

As shown in FIG. 19, one embodiment of the hardware and operating environment includes a general purpose computing device in the form of a computer 1900 (e.g., a personal computer, workstation, or server), including one or more processing units 1921, a system memory 1922, and a system bus 1923 that operatively couples various system components including the system memory 1922 to the processing unit 1921. There may be only one or there may be more than one processing unit 1921, such that the processor of computer 1900 comprises a single central-processing unit (CPU), or a plurality of processing units, commonly referred to as a multiprocessor or parallel-processor environment. In various embodiments, computer 1900 is a conventional computer, a distributed computer, or any other type of computer.

The system bus 1923 can be any of several types of bus structures including a memory bus or memory controller, a peripheral bus, and a local bus using any of a variety of bus architectures. The system memory can also be referred to as simply the memory, and, in some embodiments, includes read-only memory (ROM) 1924 and random-access memory (RAM) 1925. A basic input/output system (BIOS) program 1926, containing the basic routines that help to transfer information between elements within the computer 1900, such as during start-up, may be stored in ROM 1924. The computer 1900 further includes a hard disk drive 1927 for reading from and writing to a hard disk, not shown, a magnetic disk drive 1928 for reading from or writing to a removable magnetic disk 1929, and an optical disk drive 1930 for reading from or writing to a removable optical disk 1931 such as a CD ROM or other optical media.

The hard disk drive 1927, magnetic disk drive 1928, and optical disk drive 1930 couple with a hard disk drive interface 1932, a magnetic disk drive interface 1933, and an optical disk drive interface 1934, respectively. The drives and their associated computer-readable media provide non volatile storage of computer-readable instructions, data structures, program modules and other data for the computer 1900. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 1929, optical disk 1931, ROM 1924, or RAM 1925, including an operating system 1935, one or more application programs 1936, other program modules 1937, and program data 1938. Programming for implementing one or more processes or method described herein may be resident on any one or number of these computer-readable media.

A user may enter commands and information into computer 1900 through input devices such as a keyboard 1940 and pointing device 1942. Other input devices (not shown) can include a microphone, joystick, game pad, satellite dish, scanner, or the like. These other input devices are often connected to the processing unit 1921 through a serial port interface 1946 that is coupled to the system bus 1923, but can be connected by other interfaces, such as a parallel port, game port, or a universal serial bus (USB). A monitor 1947 or other type of display device can also be connected to the system bus 1923 via an interface, such as a video adapter 1948. The monitor 1947 can display a graphical user interface for the user. In addition to the monitor 1947, computers typically include other peripheral output devices (not shown), such as speakers and printers.

The computer 1900 may operate in a networked environment using logical connections to one or more remote computers or servers, such as remote computer 1949. These logical connections are achieved by a communication device coupled to or a part of the computer 1900; the invention is not limited to a particular type of communications device. The remote computer 1949 can be another computer, a server, a router, a network PC, a client, a peer device or other common network node, and typically includes many or all of the elements described above I/O relative to the computer 1900, although only a memory storage device 1950 has been illustrated. The logical connections depicted in FIG. 19 include a local area network (LAN) 1951 and/or a wide area network (WAN) 1952. Such networking environments are commonplace in office networks, enterprise-wide computer networks, intranets and the internet, which are all types of networks.

When used in a LAN-networking environment, the computer 1900 is connected to the LAN 1951 through a network interface or adapter 1953, which is one type of communications device. In some embodiments, when used in a WAN-networking environment, the computer 1900 typically includes a modem 1954 (another type of communications device) or any other type of communications device, e.g., a wireless transceiver, for establishing communications over the wide-area network 1952, such as the internet. The modem 1954, which may be internal or external, is connected to the system bus 1923 via the serial port interface 1946. In a networked environment, program modules depicted relative to the computer 1900 can be stored in the remote memory storage device 1950 of remote computer, or server 1949. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The following statements are provided as examples, of various embodiments.

1. A system comprising:

a physiological property sensor; and

circuitry to collect information from the physiological property sensor and transmit the information to a server, wherein the physiological property sensor and circuitry are formed as an integrated node adapted to be placed to sense a physiological property in the foot of an animal.

2. The system of example 1 wherein the physiological property sensor is shaped to be positioned between a horseshoe and a hoof of a horse.
3. The system of example 2 wherein the integrated node is shaped to be inserted into a hole formed in a horse shoe such that it is operable to sense pressure.
4. The system of example 2 or 3 wherein the integrated node is shaped to be placed on a flexible adhesive patch such that it is operable to sense a pulse.
5. The system of example 2 or 3 wherein the integrated node is shaped to be placed on a flexible adhesive patch such that it is operable to sense blood pressure.
6. The system of example 2 or 3 wherein the integrated node is shaped to be placed on a flexible adhesive patch such that it is operable to sense respiration.
7. The system of example 1, 2, 3, 4, 5, or 6 wherein the circuitry is adapted to collect information from multiple physiological property sensors in the foot of the animal and provide such collected information to the server.
8. The system of example 7 wherein the circuitry is adapted to collect information from the multiple sensors in all feet of the animal and provide such collected information to the server.
9. The system of example 1, 2, 3, 4, 5, or 6 wherein the circuitry comprises a microcontroller and a transmitter.
10. The system of example 2 wherein the integrated node is shaped to be inserted into a hole formed in a horse shoe to be coupled to a hoof such that the node is positioned to measure a parameter corresponding to at least one of impact, force, pressure, weight, and stride.
11. The system of example 2 wherein the integrated node is shaped to be attached to a horse shoe to be coupled to a hoof such that the node is positioned to measure a parameter corresponding to at least one of impact, force, pressure, weight, and stride.
12. A system comprising:

a server;

a physiological property sensor; and

circuitry to collect information from the physiological property sensor and transmit the information to the server, wherein the physiological property sensor and circuitry are formed as an integrated node adapted to be placed to sense a physiological property of an animal, and wherein the server is a particular machine programmed to compile received information and send communications to a device with a display.

13. The system of example 12 wherein compiling the received information includes determining trends in measured physiological properties.
14. The system of example 12 or 13 wherein compiling the received information includes matching measured physiological properties to predefined patterns of physiological properties.
15. The system of example 12 or 13 wherein the communications include real time pressure information that is viewable while watching the animal.
16. The system of example 12 or 13 wherein the communications include real time pressure information that is analyzed and wherein the communications include an alert of an aberration sent to the device.
17. The system of example 12 or 13 and further comprising at least one additional sensor to sense another physiological property of the animal and transmit information about such physiological property to the server.
18. A method comprising:

sensing physiological properties proximate a body part of an animal;

transmitting sensed physiological property information via a transmitter coupled to a physiological property sensor;

receiving the transmitted sensed physiological property information at a server;

processing the received sensed physiological property information by the server; and

further transmitting the processed received sensed physiological property information to a remote device proximate the animal for real time viewing of physiological property information.

19. The method of example 18 wherein the physiological property information corresponds to movement of the animal.
20. The method of example 18 or 19 wherein the physiological property corresponds to pressure between a hoof and a horseshoe of a horse.
21. The method of example 20 wherein the physiological property corresponds to the pressure at three different positions between the hoof and horseshoe.
22. The method of example 20 wherein the physiological property corresponds to pressure on four different hooves of the horse.
23. The method of example 18 or 19 wherein the physiological property corresponds to strain on a hoof of a horse.
24. The method of example 23 wherein the strain is measured along the length of a horseshoe to hoof interface.
25. The method of example 18 or 19 wherein the physiological property corresponds to temperature of a hoof of a horse.
26. The method of example 18 or 19 wherein the physiological property corresponds to body temperature of a horse.
27. The method of example 18 or 19 wherein the physiological property corresponds to respiration of a horse.
28. The method of example 18 or 19 wherein the physiological property corresponds to pulse of a horse.
29. The method of example 18 or 19 wherein the body part comprises at least one of a foot, hind-quarter, tail, or ear.

1. A system comprising:
a physiological property sensor; and
circuitry to collect information from the physiological property sensor and transmit the information to a server, wherein the physiological property sensor and circuitry are formed as an integrated node adapted to be placed to sense a physiological property in the foot of an animal.

2. The system of claim 1 wherein the physiological property sensor is shaped to be positioned between a horseshoe and a hoof of a horse.

3. The system of claim 2 wherein the integrated node is shaped to be inserted into a hole formed in a horse shoe such that it is operable to sense pressure.

4. The system of claim 2 wherein the integrated node is shaped to be placed on a flexible adhesive patch such that it is operable to sense a pulse.

5. The system of claim 2 wherein the integrated node is shaped to be placed on a flexible adhesive patch such that it is operable to sense blood pressure.

6. The system of claim 2 wherein the integrated node is shaped to be placed on a flexible adhesive patch such that it is operable to sense respiration.

7. The system of claim 1 wherein the circuitry is adapted to collect information from multiple physiological property sensors in the foot of the animal and provide such collected information to the server.

8. The system of claim 7 wherein the circuitry is adapted to collect information from the multiple sensors in all feet of the animal and provide such collected information to the server.

9. The system of claim 1 wherein the circuitry comprises a microcontroller and a transmitter.

10. The system of claim 2 wherein the integrated node is shaped to be inserted into a hole formed in a horse shoe to be coupled to a hoof such that the node is positioned to measure a parameter corresponding to at least one of impact, force, pressure, weight, and stride.

11. The system of claim 2 wherein the integrated node is shaped to be attached to a horse shoe to be coupled to a hoof such that the node is positioned to measure a parameter corresponding to at least one of impact, force, pressure, weight, and stride.

12. A system comprising:
a server;
a physiological property sensor; and
circuitry to collect information from the physiological property sensor and transmit the information to the server, wherein the physiological property sensor and circuitry are formed as an integrated node adapted to be placed to sense a physiological property of an animal, and wherein the server is a particular machine programmed to compile received information and send communications to a device with a display.

13. The system of claim 12 wherein compiling the received information includes determining trends in measured physiological properties.

14. The system of claim 12 wherein compiling the received information includes matching measured physiological properties to predefined patterns of physiological properties.

15. The system of claim 12 wherein the communications include real time pressure information that is viewable while watching the animal.

16. The system of claim 12 wherein the communications include real time pressure information that is analyzed and wherein the communications include an alert of an aberration sent to the device.

17. The system of claim 12 and further comprising at least one additional sensor to sense another physiological property of the animal and transmit information about such physiological property to the server.

18. A method comprising:
sensing physiological properties proximate a body part of an animal;
transmitting sensed physiological property information via a transmitter coupled to a physiological property sensor;
receiving the transmitted sensed physiological property information at a server;
processing the received sensed physiological property information by the server; and
further transmitting the processed received sensed physiological property information to a remote device proximate the animal for real time viewing of physiological property information.

19. The method of claim 18 wherein the physiological property information corresponds to movement of the animal.

20. The method of claim 18 wherein the physiological property corresponds to pressure between a hoof and a horseshoe of a horse.

21. The method of claim 20 wherein the physiological property corresponds to the pressure at three different positions between the hoof and horseshoe.

22. The method of claim 20 wherein the physiological property corresponds to pressure on four different hooves of the horse.

23. The method of claim 18 wherein the physiological property corresponds to strain on a hoof of a horse.

24. The method of claim 23 wherein the strain is measured along the length of a horseshoe to hoof interface.

25. The method of claim 18 wherein the physiological property corresponds to temperature of a hoof of a horse.

26. The method of claim 18 wherein the physiological property corresponds to body temperature of a horse.

27. The method of claim 18 wherein the physiological property corresponds to respiration of a horse.

28. The method of claim 18 wherein the physiological property corresponds to pulse of a horse.

29. The method of claim 18 wherein the body part comprises at least one of a foot, hind-quarter, tail, or ear.
